(19) United States
(12) Patent Application Publication
(10) Pub. No.: US 2005/0197029 A1
(43) Pub. Date: Sep. 8, 2005

(54) Multi-density polyester fiber panel

(75) Inventors: Myong Guk Jeong, Nam-gu (KR); Sang Min Jung, Dongnae-gu (KR); Jae Hak Lee, Seocho-gu (KR)

Correspondence Address: JORDAN AND HAMBURG LLP, 122 EAST 42ND STREET, SUITE 4000, NEW YORK, NY, 10168, US

(73) Assignee: SK Chemicals Co., Ltd., Suwon-si (KR)

(21) Appl. No.: 10/953,290

(22) Filed: Sep. 29, 2004

(30) Foreign Application Priority Data
Mar. 8, 2004 (KR) 10-2004-0015409

(51) Int. Cl. B32B 5/26; B32B 27/02; D04H 1/00

(52) U.S. Cl. 442/409; 442/415; 442/381; 442/392

(57) ABSTRACT

Disclosed is a multi-density polyester fiber panel, which includes a polyester binder fiber, containing low melting point polyester with a melting point of 100° C. to 160° C., and a high melting point polyester matrix fiber. The multi-density polyester fiber panel includes an interior part, and surface parts layered on both sides of the interior part. At this time, each of the surface parts contains polyester matrix fiber having 2 to 4 times larger monofilament fineness than polyester matrix fiber contained in the interior part, and has a different density from the interior part. Therefore, the multi-density polyester fiber panel, which has a noise-absorbing ability improved by about 20% or more without the reduction of bending strength, in comparison with a conventional polyester fiber panel, can be efficiently used as a substitute of a glass wool panel with relatively high strength and density.

### BACKGROUND OF THE INVENTION

1. Field of the Invention

The present invention relates, in general, to a multi-density polyester fiber panel and, more particularly, to a multi-density polyester fiber panel, which includes a surface part and an interior part, having different fiber compositions and densities, thereby optimizing noise-absorbing ability and bending strength thereof, incompatible with each other. Accordingly, the multi-density polyester fiber panel of the present invention can be efficiently used as a substitute for glass wool with relatively high strength and density.

2. Description of the Prior Art

Glass wool and rock wool have been frequently used as an adiabatic and noise-absorbing material, but are problematic in that harmful substances are released from the glass and rock wools and it is difficult to regenerate the used glass and rock wools. To avoid the above problems, efforts have been made to use a polyester floss, having been frequently used as bedclothes, such as mattresses for beds, instead of the glass wool or rock wool. The use of the polyester floss is spotlighted in accordance with the recent trend of the protection of environment all over the world because it is an environmentally-friendly material which is harmless to humans and can be easily regenerated, in comparison with a conventional adiabatic and noise-absorbing material. However, when a polyester panel, produced using the polyester floss, has a relatively high density of 80 kg/m³ or more, the polyester panel has poorer bending strength than an inorganic fiber panel made of the glass wool or rock wool. Hence, the polyester panel is scarcely applied to a building material or an interior decoration material. Meanwhile, studies have been conducted to develop processes of post-processing a polyester floss using a hot plate press or a hot press roller so as to improve the bending strength of a polyester panel, including the polyester floss, as disclosed in Korean Pat. Registration Publication Nos. 10-2003-0398507 and 10-2002-0350729. However, these processes are disadvantageous in that the polyester panel is still poor in terms of a noise-absorbing ability even though the polyester panel has the improved bending strength.

### SUMMARY OF THE INVENTION

Therefore, the present invention has been made keeping in mind the above disadvantages occurring in the prior arts, and an object of the present invention is to provide a novel noise-absorbing polyester fiber panel.

The present inventors have conducted extensive studies to realize the above object, resulting in the finding that when a fiber composition and a density distribution of a polyester fiber panel are properly changed without increasing a total density of the polyester fiber panel, the polyester fiber panel has a similar density and strength to a glass wool with relatively high density and strength, and also has an improved noise-absorbing ability while preventing bending strength of the polyester fiber panel from being reduced, thereby accomplishing the present invention.

In order to accomplish the above object, the present invention provides a multi-density polyester fiber panel, which includes a polyester binder fiber, containing low melting point polyester with a melting point of 100° C. to 160° C., and a high melting point polyester matrix fiber. The multi-density polyester fiber panel includes an interior part, and surface parts layered on both sides of the interior part. At this time, each of the surface parts contains polyester matrix fiber having 2 to 4 times larger monofilament fineness than polyester matrix fiber contained in the interior part, and has a different density from the interior part.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a side sectional view of a multi-density polyester fiber panel according to the present invention; and

FIG. 2 is a flow chart illustrating the production of the multi-density polyester fiber panel according to the present invention.

### DETAILED DESCRIPTION OF THE INVENTION

Reference now should be made to the drawings, in which the same reference numerals are used throughout the different drawings to designate the same or similar components.

A multi-density polyester fiber panel according to the present invention includes a polyester binder fiber and a polyester matrix fiber, and consists of an interior part and surface parts. At this time, the interior part and each surface part have different densities from each other. The polyester binder fiber contains only or some low melting point polyester with the melting point of 100° C. to 160° C., and the polyester matrix fiber contains polyester with the higher melting point than polyester constituting the polyester binder fiber.

Preferably, each of the surface parts 1 of the polyester fiber panel according to the present invention includes 60 to 80 wt % of polyester binder fiber, containing only or some the low melting point polyester with a monofilament fineness of two to six deniers and the melting point 100 to 160° C., and 20 to 40 wt % of polyester matrix fiber with the monofilament fineness of 15 to 25 deniers. At this time, it is preferable that a thickness of each of the surface parts 1 of the polyester fiber panel is 5 to 15% of a total thickness of the polyester fiber panel. More preferably, each of the surface parts 1 of the polyester fiber panel includes 60 wt % of polyester binder fiber with the monofilament fineness of four deniers and 30 wt % of polyester matrix fiber with the monofilament fineness of 18 deniers, and the thickness of each of the surface parts 1 of the polyester fiber panel is 10% of the total thickness of the polyester fiber panel.

When the monofilament fineness of the polyester matrix fiber is less than 15 deniers or the thickness of each of the surface parts 1 is less than 5% of the total thickness of the entire polyester fiber panel, rigidity of each surface part 1 is reduced, and thus, the polyester fiber panel does not have a desired level of bending strength. On the other hand, when the monofilament fineness of the polyester matrix fiber is more than 25 deniers or the thickness of each surface part 1 is more than 15% of the total thickness of the entire polyester fiber panel, the rigidity of each surface part 1 is improved to allow the polyester fiber panel to have the desired bending strength, but a noise-absorbing ability of the polyester fiber panel is reduced.

As for the interior part 2 of the polyester fiber panel according to the present invention, it is preferable that the interior part 2 of the polyester fiber panel includes 60 to 80 wt % of polyester binder fiber, containing only or some low melting point polyester with the monofilament fineness of 2 to 6 deniers and the melting point 100 to 160° C., and 20 to 40 wt % of polyester matrix fiber with the monofilament fineness of 4 to 10 deniers. Additionally, preferably, the thickness of the interior part 2 of the polyester fiber panel is 70 to 90% of the total thickness of the entire multi-density polyester fiber panel. More preferably, the interior part 1 of the polyester fiber panel includes 70 wt % of polyester binder fiber with the monofilament fineness of four deniers and 30 wt % of polyester matrix fiber with the monofilament fineness of eight deniers, and the thickness of the interior part 2 of the polyester fiber panel is 80% of the total thickness of the entire polyester fiber panel.

When the monofilament fineness of the polyester matrix fiber is more than 10 deniers or the thickness of the interior part 2 is less than 70% of the total thickness of the entire polyester fiber panel, the rigidity of the interior part 2 is improved, but the polyester fiber panel does not have the desired noise-absorbing ability. On the other hand, when the monofilament fineness of the polyester matrix fiber is less than four deniers or the thickness of the interior part 2 is more than 90% of the total thickness of the entire polyester fiber panel, the noise-absorbing ability of the polyester fiber panel is improved, but the rigidity of the interior part 2 is reduced which reduces the bending strength of the polyester fiber panel. Particularly, the polyester fiber panel has excellent strength and noise-absorbing ability when the monofilament fineness of the polyester matrix fiber in the surface parts is 2 to 4 times larger than that of the polyester matrix fiber in the interior part.

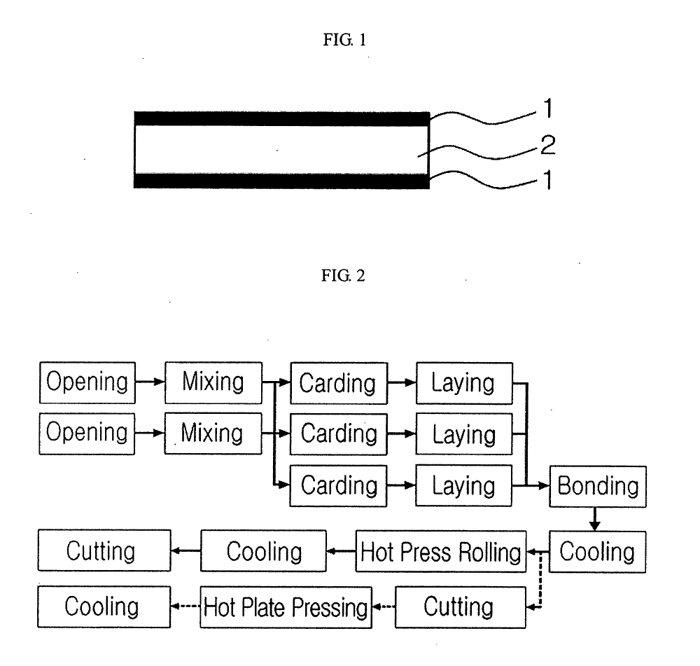

With reference to FIG. 1, there is illustrated the polyester fiber panel, which includes one layer of interior part. However, in consideration of production efficiency of the polyester fiber panel, after polyester fiber panels having two layers or more interior parts are separately produced, the polyester fiber panels may be heat-attached to each other to accomplish the polyester fiber panel having a multilayered interior part. According to the present invention, the rigidity of each surface part of the polyester fiber panel contributes to improving the bending strength of the polyester fiber panel, and a fine air layer in the interior part of the polyester fiber panel contributes to improving the noise-absorbing ability of the polyester fiber panel. Furthermore, in case that the polyester fiber panel has a structure in which a plurality of surface and interior parts are alternately laminated, the polyester fiber panel may realize various effects and performances. In addition, a layer structure of the polyester fiber panel may be changed, or other fiber materials may be added, in addition to polyester, into the polyester fiber panel according to the use and required performances of the polyester fiber panel.

As well, it is preferable that the polyester fiber panel, including a sandwich structure in which the one interior part is sandwiched between the two surface parts, has the thickness of 13 to 50 mm and the density of 80 to 150 kg/m³. The present invention may provide the multi-density polyester fiber panel, having the thickness of 25 mm, the noise-absorptivity of 0.5 to 0.7 NRC, the bending strength of 30 to 50 N/cm², and the compression strength of 4 to 6 N/cm², which realize similar performances to a glass wool panel with the relatively high density and strength, unlike a conventional polyester fiber panel. Hence, the environmentally-friendly polyester fiber panel of the present invention may be efficiently used as a substitute of the glass wool panel.

Hereinafter, a detailed description will be given of the production of the multi-density polyester fiber panel.

A binder fiber and a matrix fiber are mixed with each other in a mixing ratio, corresponding to a fiber composition ratio of each surface part of the polyester fiber panel, to form surface webs using two carding units. Additionally, the binder and matrix fibers are mixed with each other in a mixing ratio, corresponding to a fiber composition ratio of the interior part of the polyester fiber panel, to form an interior web using one carding unit. Subsequently, the surface and interior webs are laminated in such a way that the interior part is sandwiched between the two surface parts to produce a web laminate, and the web laminate is preheated using a preheating unit so that fibers of the web laminate are neatly arranged when the web laminate is transmitted into a heat-treating unit. The web laminate is heat-treated using the heat-treating unit at a temperature higher than a melting point of the binder fiber and lower than a melting point of the matrix fiber, preferably at 120 to 170° C., to produce heat-treated floss. A surface of the heat-treated floss is then cooled using a cooling unit, and the cooled floss is passed through one to three sets of upper and lower hot press rollers. In this regard, temperatures of the hot press rollers are preferably 150 to 250° C., which is higher than the temperature of the heat-treatment of the floss.

The reason why the surface of the floss is cooled using the cooling unit after the floss is heat-treated is that if the heat-treated floss is directly transmitted to the hot press rollers, the hot floss is easily attached to the hot press rollers due to heat remaining on the surface of the floss. Instead of a continuous procedure, the floss, heat-treated and cooled, may be cut in a desired size, heated and pressed using a hot plate press, and then cooled. At this time, it is preferable that a temperature of the hot plate press is 150 to 250° C., which is higher than the temperature of the heat-treatment of the floss.

Having generally described this invention, a further understanding can be obtained by reference to examples and comparative examples which are provided herein for the purposes of illustration only and are not intended to be limiting unless otherwise specified.

### EXAMPLE 1

70 wt % of sheath-core polyester conjugated yarn with a monofilament fineness of four deniers (melting point of a sheath part: 120° C.), acting as a binder fiber, and 30 wt % of polyester fiber with the monofilament fineness of 18 deniers (melting point: 260° C.), acting as a matrix fiber, were subjected to an opening process, and mixed with each other to produce first webs using two carding units. The first webs were laminated to produce surface webs. Additionally, 70 wt % of sheath-core polyester conjugated yarn with the monofilament fineness of four deniers (melting point of a sheath part: 120° C.), acting as the binder fiber, and 30 wt % of polyester fiber with the monofilament fineness of eight deniers (melting point: 260° C.), acting as the matrix fiber, were subjected to the opening process, and mixed with each other to produce second webs using a carding unit. The second webs were laminated to produce an interior web. The surface and interior webs were laminated in such a way that an interior part is sandwiched between two surface parts, preheated, and heat treated at 150° C. to heat attach the binder fiber to the matrix fiber. The binder fiber and matrix fiber attached to each other were cooled, cut, and pressed using a hot plate press of 10 kgf/cm² or more while being heated at 230° C. for a retention time of 90 seconds to produce a sample.

### COMPARATIVE EXAMPLES 1 TO 3

Samples, each having a thickness, a density, and a fiber composition as described in the Table 1, were produced according to a conventional process. In this regard, none of the samples had a sandwich structure of the example 1. Noise-absorbing abilities and bending strengths of the samples were evaluated, and the results are described in Table 2.

### COMPARATIVE EXAMPLE 4

A noise-absorbing ability and bending strength of a glass wool plate, having strength and density as described in the Table 1, were evaluated, and the results are described in the Table 2.

Noise-absorbing abilities, bending strengths, and compression strengths of samples according to the example 1 and the comparative examples 1 to 4 were evaluated as follows:
Noise-absorbing ability: The samples were tested using a transfer function method, and the noise-absorbing abilities of the samples were evaluated using an NRC value, used as a single numerical representative value of test results of reverberation absorptivity, based on a KS F 2814-2 method (a method of determining a noise-absorbing coefficient and an impedance using an impedance tube),
Bending strength: The bending strengths of the samples were evaluated according to a KS M 3808 method (test method of a foamed polystyrene insulating material),
Compression strength: The compression strengths of the samples were evaluated according to a KS M 3808 method (test method of a foamed polystyrene insulating material),

In this regard, a load is based on the samples pressed by 20%. The results are described in the Table 2.

TABLE 1

| | | | Surface part | | Interior part | |
|---|---|---|---|---|---|---|
| | Thickness | Density | (fineness) | | (fineness) | |
| | (mm) | (kg/m³) | Binder | Matrix | Binder | Matrix |
| Ex. 1 | 25 | 120 | 4denier | 18denier | 4denier | 8denier |
| | | | 70 wt % | 30 wt % | 70 wt % | 30 wt % |
| Co. | 25 | 120 | 4denier | 18denier | 4denier | 18denier |
| Ex. 1 | | | 60 wt % | 40 wt % | 40 wt % | 60 wt % |
| Co. | 25 | 120 | 4denier | 8denier | 4denier | 8denier |
| Ex. 2 | | | 70 wt % | 30 wt % | 70 wt % | 30 wt % |
| Co. | 25 | 120 | 4denier | 18denier | 4denier | 18denier |
| Ex. 3 | | | 70 wt % | 30 wt % | 70 wt % | 30 wt % |
| Co. | 25 | 100 | Glass | Glass | Glass | Glass wool |
| Ex. 4 | | | wool | wool | wool | |

TABLE 2

| | Noise- | Bending | Compression |
|---|---|---|---|
| | absorptivity | strength | strength |
| | (NRC) | (N/cm²) | (N/cm²) |
| Ex. 1 | 0.52 | 31.6 | 5.4 |
| Co. Ex. 1 | 0.42 | 34.9 | 5.5 |
| Co. Ex. 2 | 0.52 | 25.1 | 2.5 |
| Co. Ex. 3 | 0.44 | 35.7 | 5.7 |
| Co. Ex. 4 | 0.51 | 42.5 | 4.1 |

As apparent from the above description, the present invention provides a multi-density polyester fiber panel, which has a noise-absorbing ability improved by about 20% or more without the reduction of bending strength, in comparison with a conventional polyester fiber panel. Therefore, the multi-density polyester fiber panel according to the present invention can be efficiently used as a substitute of a glass wool panel with relatively high strength and density.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. A multi-density polyester fiber panel, which includes a polyester binder fiber, containing low melting point polyester with a melting point of 100 to 160° C., and a high melting point polyester matrix fiber, comprising:
an interior part; and
surface parts layered on both sides of the interior part, each of which contains polyester matrix fiber having 2 to 4 times larger monofilament fineness than polyester matrix fiber contained in the interior part, and has a different density from the interior part.

2. The multi-density polyester fiber panel as set forth in claim 1, wherein the panel has a thickness of 13 to 50 mm and a density of 80 to 150 kg/m³.

3. The multi-density polyester fiber panel as set forth in claim 1, wherein each of the surface parts includes 60 to 80 wt % of polyester binder fiber with a monofilament fineness of two to six deniers and 20 to 40 wt % of polyester matrix fiber with the monofilament fineness of 15 to 25 deniers, and a thickness of each of the surface parts is 5 to 15% of a total thickness of the multi-density polyester fiber panel.

4. The multi-density polyester fiber panel as set forth in claim 1, wherein the interior part includes 60 to 80 wt % of polyester binder fiber with the monofilament fineness of two to six deniers and 20 to 40 wt % of polyester matrix fiber with the monofilament fineness of four to ten deniers, and a thickness of the interior part is 70 to 90% of a total thickness of the multi-density polyester fiber panel.

5. The multi-density polyester fiber panel as set forth in claim 3, wherein the panel has a thickness of 25 mm, a noise-absorptivity of 0.5 to 0.7 NRC, bending strength of 30 to 50 N/cm², and compression strength of 4 to 6 N/cm².
